(19) United States
(12) Patent Application Publication
(10) Pub. No.: US 2017/0232668 A1
(43) Pub. Date: Aug. 17, 2017

(54) 3D Printing System

(71) Applicant: Institute of Automation Chinese Academy of Sciences, BEIJING (CN)

(72) Inventors: Zhen Shen, Beijing (CN); Di TANG, Beijing (CN); Gang Xiong, Beijing (CN); Feiyue Wang, Beijing (CN)

(21) Appl. No.: 15/314,071

(22) PCT Filed: May 26, 2014
(86) PCT No.: PCT/CN2014/078433

§ 371 Date: Apr. 14, 2017

(51) Int. Cl. B29C 67/00; B33Y 50/02; B33Y 30/00

(52) U.S. Cl. CPC B29C 67/0066; B29C 67/0088; B33Y 30/00; B33Y 50/02

(57) ABSTRACT

A 3D printing system comprises: a digital micro-mirror device (DMD) mobile device (1); a light source (3), fixed on said DMD mobile device (1) for emitting ultraviolet light, blue light or visible light; multiple DMDs (2) carried on the DMD mobile device (1) for receiving the ultraviolet light, blue light or visible light emitted by the light source (3) and generating 3D object section light; a lens (4) for receiving the 3D object section light reflected by the DMDs (2) and refracting and amplifying the 3D object section light; a material box (5) for containing and providing printing materials; a workbench (6), wherein the 3D object section light refracted by the lens irradiates the printing materials provided by the material box (5) to solidify the printing materials into a 3D object carried on the workbench (6); and a lifting device (7) for lifting the workbench (6). By changing a system structure and moving an original DMD or splicing multiple DMDs, the 3D printing system of the present invention flexibly prints a 3D printing object having a larger sectional area and a constant DPI.

### TECHNICAL FIELD

The present invention relates to a 3D printing system, in particular to a 3D printing system that employs Digital Light Processing (DLP).

### BACKGROUND OF THE INVENTION

The digital light processing technology is an imaging technology used in projectors and rear-projection TVs and first digitally processes image signals and then projects light. In a digital light processing projector, images are generated by a Digital Micro-mirror Device (DMD). The DMD is formed by arranging a matrix consisting of micro-mirrors (precise micro-mirrors) on a semiconductor chip, each micro-mirror controlling one pixel in the projected image, namely, the digital light processing projection technology uses digital micro-mirror chips as the main processing element to realize the digital light processing.

3D printing is a kind of rapid prototyping technology, which uses software to perform a layered discretization to a 3D model, and uses a numerically controlled prototyping system to perform prototyping scanning on such special materials as the resin, the ceramic powder and the plastic layer by layer on an X-Y plane by means of laser beams, ultraviolet rays, hot melt, etc., and to perform stacking bond on axis Z to finally superpose into an entitative product.

By combining the digital light processing technology with the 3D printing technology, the digital light processing 3D printing technology is obtained, which is a kind of 3D printing technology. It uses a high-resolution DLP device and an ultraviolet light source to project a section of a 3D object onto a workbench and makes a liquid photopolymer (photosensitive resin) to be light-solidified layer by layer. After the completion of the solidification of the i^{th} layer, the 3D printer controls the axis Z to lift the workbench by the thickness of one layer so as to solidify the (i+1)^{th} layer. This process repeats until the model is completely constructed.

There must be one and only one DMD inside the existing digital light processing printer, and said DMD must be fixed, which results in various restrictions, such as fixed bottom area of the printed object. There has not been any solution to the restrictions caused by the fixed DMD at present, so changing the state of fixation of the DMD in the digital light processing printer is a problem that needs to be solved urgently.

### SUMMARY OF THE INVENTION

The object of the present invention is to provide a 3D printing system that can effectively increase the sectional area of the printed object so as to overcome the defects in the prior art.

To achieve the above object, the present invention provides a 3D printing system, which comprises:

a digital micro-mirror device (DMD) mobile device;

a light source fixed on said DMD mobile device for emitting ultraviolet light, blue light or visible light;

multiple DMDs carried on the DMD mobile device for receiving the ultraviolet light, blue light or visible light emitted by the light source and generating 3D object section light;

a lens for receiving the 3D object section light reflected by the DMDs and refracting and amplifying the 3D object section light;

a material box for containing and providing printing materials;

a workbench, wherein the 3D object section light refracted by the lens irradiates on the printing materials provided by the material box to solidify the printing materials into a 3D object carried on the workbench; and

a lifting device for lifting the workbench.

Further, said DMD is a matrix consisting of micro-mirrors, each of said micro-mirrors correspondingly controls one pixel in the projected image.

Further, said micro-mirrors change their angles under the control of digital driving signals generated by a DLP control panel.

Further, the DMD mobile device is specially a splicing-type DMD mobile device, each of said DMDs corresponds to one of the light sources, and the light source and the DMD of each group are fixed together.

Further, the DMD mobile device is specifically a bar-shape moving type DMD mobile device, each of said DMDs corresponds to one of the light sources, and the light source and the DMD of each group are fixed together and move synchronously on a bar basis.

Further, said DMDs move in parallel along a first direction so as to print a first layer of the 3D object, and said DMDs move in parallel along a direction opposite to the first direction so as to print a second layer of the 3D object.

Further, said DMD mobile device is specifically a block-shape moving type DMD mobile device, each of said DMDs corresponds to one of said light sources, and the light source and the DMD of each group are fixed together and move synchronously on a block basis.

Further, each of said DMDs corresponds to a printing area and prints the corresponding printing area layer by layer so as to print the 3D object.

Further, said printing material is photosensitive resin.

Further, said lifting device is specifically used for lifting the workbench after completion of printing of a first layer of the 3D object on the workbench so as to print a second layer of the 3D object.

By changing a system structure and moving an original DMD or splicing multiple DMDs, the 3D printing system of the present invention flexibly prints a 3D printing object having a larger sectional area and a constant DPI.

### BRIEF DESCRIPTION OF THE DRAWINGS

FIG. 1 is one of the three schematic views of the 3D printing system of the present invention;

FIG. 2 is a second one of the three schematic views of the 3D printing system of the present invention;

FIG. 3 is a third one of the three schematic views of the 3D printing system of the present invention.

### DETAILED DESCRIPTION OF THE INVENTION

The technical solution of the present invention will be described in further detail below with reference to the drawings and in conjunction with the specific embodiments.

The 3D printing system of the present invention is a DLP 3D printing system with moving-type/splicing type DMDs, and the method of moving in parallel the original fixed DMDs inside the printing system or splicing multiple DMDs. The present invention mainly intends to increase the sectional area of the 3D printing object under the condition that the number of DMD micro-mirrors is fixed, namely, while keeping the original dots per inch (DPI) unchanged, the bottleneck problem that the sectional area of the object printed by the existing 3D printing system cannot exceed the light projection range of a single fixed DMD is solved.

The 3D printing system of the present invention moves or splices the fixed DMDs of a printing system, thus breaking restrictions like a fixed bottom area of the 3D object printed by the existing DMD, and utilizing the existing 3D printing system resource to the maximum.

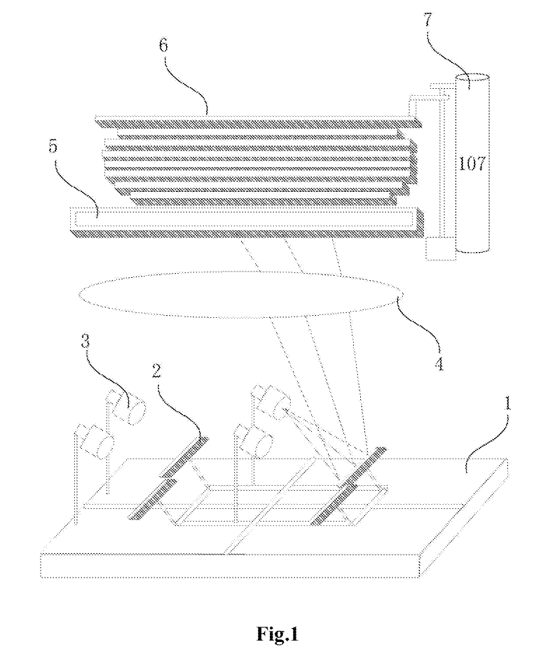

FIGS. 1, 2 and 3 are three schematic drawings of the 3D printing system of the present invention. As shown in the figures, the 3D printing system of the present invention comprises a DMD mobile device 1, a light source 3, a DMD 2, a lens 4, a material box 5, a workbench 6 and a lifting device 7.

In this embodiment, the number of the DMDs that are spliced and the number N of equally divided parts of the area to be printed are both set to be 4, namely, 4 DMDs are spliced, or the area to be printed is equally divided into 4 parts.

The light source 3 is fixed on the DMD mobile device 1 for emitting ultraviolet light, blue light or visible light; the DMD 2 is loaded on the DMD mobile device 1 for receiving the ultraviolet light, blue light or visible light emitted by the light source 3 and generating the 3D object section light; the lens 4 is used for receiving the 3D object section light reflected by the DMD 2 and refracting and amplifying the 3D object section light; the material box 5 is used for containing and providing printing materials, specifically, the printing material can be photosensitive resin; the 3D object section light refracted by the lens 4 irradiates the printing material provided by the material box 5 to solidify the printing materials into a 3D object loaded on the workbench 6; and the lifting device 7 is used for lifting the workbench 6.

Specifically, the DMD 2 is a matrix consisting of micro-mirrors, each micro-mirror controlling one pixel in the projected image, and the number of the micro-mirrors complies with the resolution of the projected image. The micro-mirrors can quickly change their angles under the control of the digital driving signals which are controlled by the DLP control panel. Thus, by using the DLP control panel to control the digital drive signals and then using the digital drive signals to control the angles of the micro-mirrors, the DMD can generate a section of a 3D object.

Further, the moving-type or splicing-type digital micro-mirror device is realized through that the DMD mobile device 1 moves the DMD 2 or carries multiple DMDs 2. In order to realize the splicing-type DMD, 2 to N DMDs 2 need to be spliced as desired, and the rules of splicing are mainly depending on the user's demands, but usually symmetric dividing is adopted. The area to be printed is equally divided into N parts with a DMD placed on each part, and each DMD is provided with a light source. During printing, N DMDs coordinate to print, and the key point of the printing is processing of the edges by every two adjacent DMDs, and the integrity and smooth transition of the printed object shall be guaranteed.

FIG. 1 shows a splicing-type DMD mobile device. The DMD mobile device 1 can be a splicing-type DMD mobile device and it can be used to carry DMDs and light sources. Each DMD is provided with a light source, the light source and the DMD of each group are fixed together, and the method of the splicing-type digital micro-mirrors device does not require to move the DMDs and the light sources.

In order to realize the moving-type DMD, two ways of movement are adopted, i.e. bar-shape movement and block-shape movement.

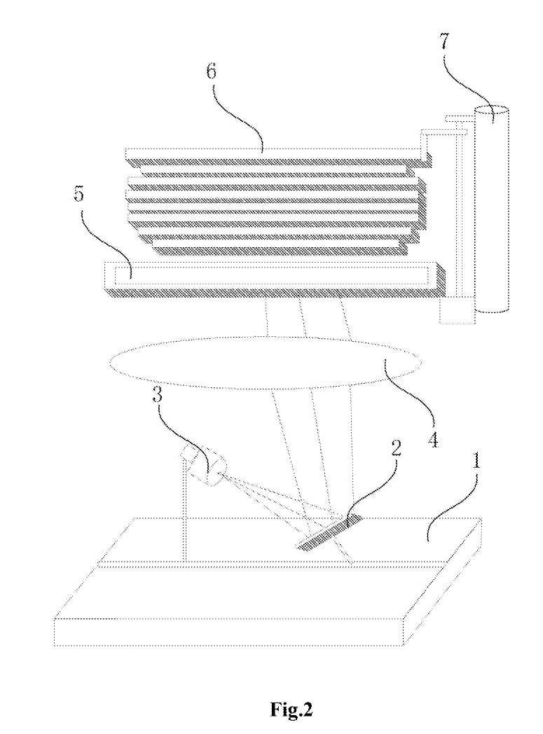

FIG. 2 shows a bar-shape moving-type DMD mobile device, wherein the bar-shape movement refers to that the DMDs move in parallel along a first direction so as to print a first layer of the 3D object, and that the DMDs move in parallel along a direction opposite to the first direction so as to print a second layer of the 3D object. Specifically, an i^{th} layer is printed by moving in parallel along one direction, e.g. moving from left to right, and then an (i+1)^{th} layer is printed by moving from right to left, and this process is repeated until printing of the entire object is finished. The bar-shape movement is suitable for printing the 3D objects having large sectional areas and aspect ratios.

Still referring to FIG. 2, the DMD mobile device 1 is a bar-shape moving-type DMD mobile device, and the DMD 2 can only move back and forth on said device in a bar shape; the light source 3 is fixed together with the DMD 2, so that they move together: by one movement from left to right, the cross-section of the i^{th} layer of the 3D object is printed, and by one movement from right to left, the cross-section of the (i+1)^{th} layer of the 3D object is printed, and this flow repeats until the 3D object is completed printed.

In addition, the DMD mobile device 1 can be a bar-shape moving-type DMD mobile device for moving the DMD. Like the splicing-type, the DMD and light source here are fixed together to move synchronously on a bar basis.

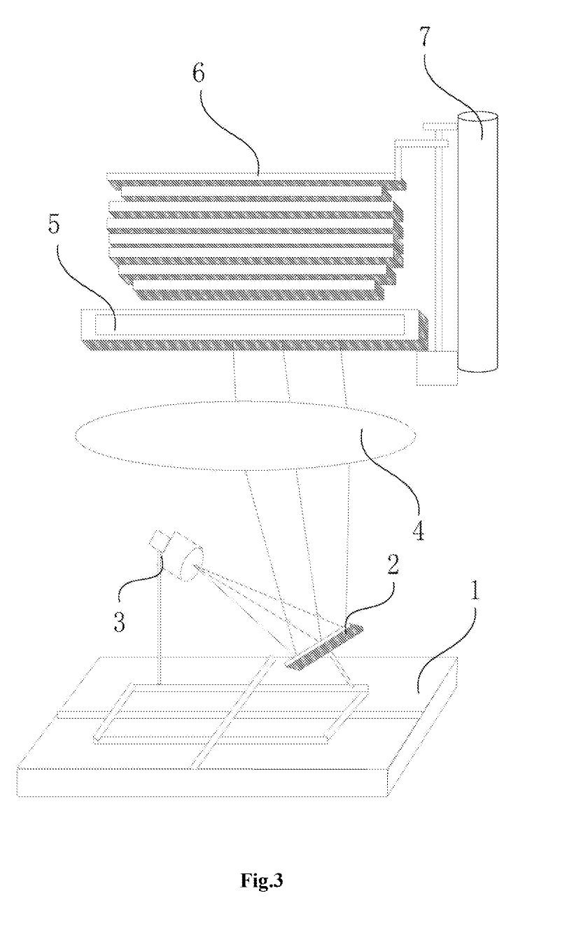

FIG. 3 shows a block-shape moving-type DMD mobile device, the block-shape movement is similar to the splicing-type DMD, each DMD corresponds to one printing area, and each DMD prints, layer by layer, the corresponding printing area so as to print the entire 3D object.

Specifically, the area to be printed is equally divided into N parts, and the DMD moves from part 1 to part N in turn, when all parts have been printed, the printing of the i^{th} layer is completed, and the lifting device lifts up by the thickness of one layer to start printing the (i+1)^{th} layer. The key point of the printing is that the printing interval from part 1 to part N should not be too long, so that the parts printed earlier will not solidify before the parts printed later, and integrity and smooth transition of the printed object shall also be guaranteed. The block-shape movement is suitable for printing 3D objects having large sectional areas but small aspect ratios.

At this time, the DMD mobile device 1 can be a block-shape moving-type DMD mobile device for moving the DMD. The DMD and light source herein are the same as the bar-shape moving-type DMD mobile device, and they are fixed together to move synchronously on a block basis.

Still referring to FIG. 3, the DMD mobile device 1 is a block-shape movement DMD mobile device, and the DMD 2 can move in proper order to adjacent block-shape areas for printing. The light source 3 is fixed together with DMD 2 to move together. In the 3D printing system shown in FIG. 3, the area to be printed is equally divided into 4 parts, and the DMD 2 moves from part 1 to part 4 in turn to finish one printing of the cross-section of the 3D object. The process of the DMD moving to each part shall be accompanied by switching of the image to be printed on the DMD, and during printing, the moving speed of the DMD in two adjacent printing areas should be adapted to the speed of switching of the printing image of the DMD as well as the speed of solidification of the photosensitive resin so as to avoid solidification of the parts printed earlier being before solidification of the parts printed later, which will influence the integrity and smoothness of the printed object. After finishing printing of the cross-section of the i^{th} layer of the 3D object, the process is repeated to print the cross-section of the (i+1)^{th} layer of the 3D object, until the 3D object is completely printed.

The light source 3 emits ultraviolet light, blue light or visible light which irradiates the photosensitive resin to solidify it. The ultraviolet light, blue light or visible light emitted by the light source irradiates on the DMD and the DMD reflects the generated 3D object section light to the lens, then the lens refracts the light to the photosensitive resin which will solidify to form a 3D object section.

The lens 4 is used for refracting the ultraviolet light, blue light or visible light reflected by the DMD, in order to enlarge the range of irradiation of the ultraviolet light, blue light or visible light. The DMD 2 generates the cross-section of the 3D object to be printed. The DMD controls the angles of the micro-mirrors with a software system to display the cross-section of the 3D object to be printed, and the DMD functions to reflect the ultraviolet light, blue light or visible light projected from the light source 3 to the lens 4 and to project ultraviolet light, blue light or visible light having the shape of the cross-section of the 3D object. The lens 4 amplifies the ultraviolet light, blue light or visible light having the shape of the 3D object cross-section reflected from the DMD, and refracts it to the photosensitive resin that serves as the 3D printing material so as to solidify the section of the 3D object.

The material box 5 is a container for containing the printing material, and the printing material used herein is the photosensitive resin. The workbench 6 fixes the photosensitive resin 3D object generated by solidification. The lifting device 7 is used for lifting the workbench by the thickness of one layer upon completion of solidification of the i^{th} layer photosensitive resin so as to solidify the (i+1)^{th} layer, until the model is completely constructed, i.e. the entire object is printed.

The present invention has the following advantageous: in the case where the number of micro-mirrors on the existing single fixed DMD area cannot be increased, it breaks the inherent mode of thinking for 3D printing and changes the structure of the 3D printing system to move the original DMD or splice multiple DMDs, thereby flexibly printing a 3D printing object having a larger sectional area and a constant DPI.

Those skilled in the art shall further realize that the invention can be implemented by electronic hardware, computer software or a combination thereof in conjunction with the exemplary units and algorithm steps described in the embodiments disclosed herein. In order to illustrate interchangeability of hardware and software, the construction and steps of each example have been generally described in terms of the functions. As for whether said functions are achieved by hardware or software, it depends on the specific application and restrictions of design of the technical solution. Those skilled in the art can use a different method for each specific application so as to achieve the described functions, but such implementation shall not be considered as going beyond the scope of the present invention.

The steps of method or algorithm described in conjunction with the embodiment disclosed herein can be carried out by hardware, software modules executed by a processor or by a combination thereof. The software modules can be disposed in a random access memory (RAM), a memory, a read-only memory (ROM), an electrically-programmable ROM, an electrically erasable programmable ROM, a register, a hard disc, a removable disc, a CD-ROM or any other form of storage medium known in the art.

The above-described specific embodiment describes in detail the object, technical solution and advantageous effect of the present invention. But it shall be appreciated that all the above described is merely a specific embodiment of the present invention, which do not intend to limit the protection scope of the invention. Any modification, equivalent substitution and improvement made under the spirit and principle of the present invention shall fall within the protection scope of the present invention.

1. A 3D printing system, characterized in that said system comprises:
a digital micro-mirror device DMD mobile device;
a light source fixed on said DMD mobile device for emitting ultraviolet light, blue light or visible light;
multiple DMDs carried on the DMD mobile device for receiving the ultraviolet light, blue light or visible light emitted by the light source and generating 3D object section light;
a lens for receiving the 3D object section light reflected by the DMDs and refracting and amplifying the 3D object section light;
a material box for containing and providing printing materials;
a workbench, wherein the 3D object section light refracted by the lens irradiates the printing materials provided by the material box to solidify the printing materials into a 3D object carried on the workbench; and
a lifting device for lifting the workbench.

2. The system according to claim 1, characterized in that said DMD is a matrix consisting of micro-mirrors, each of said micro-mirrors correspondingly controls one pixel in the projected image.

3. The system according to claim 1, characterized in that said micro-mirrors change their angles under the control of digital driving signals generated by a DLP control panel.

4. The system according to claim 1, characterized in that the DMD mobile device is specially a splicing-type DMD mobile device, each of said DMDs corresponds to one of the light sources, and the light source and the DMD of each group are fixed together.

5. The system according to claim 1, characterized in that the DMD mobile device is specifically a bar-shape moving type DMD mobile device, each of said DMDs corresponds to one of the light sources, and the light source and the DMD of each group are fixed together and move synchronously on a bar basis.

6. The system according to claim 5, characterized in that said DMDs move in parallel along a first direction so as to print a first layer of the 3D object, and said DMDs move in parallel along a direction opposite to the first direction so as to print a second layer of the 3D object.

7. The system according to claim 1, characterized in that said DMD mobile device is specifically a block-shape moving type DMD mobile device, each of said DMDs corresponds to one of said light sources, and the light source and the DMD of each group are fixed together and move synchronously on a block basis.

8. The system according to claim 7, characterized in that each of said DMDs corresponds to a printing area and prints the corresponding printing area layer by layer so as to print the 3D object.

9. The system according to claim 1, characterized in that said printing material is photosensitive resin.

10. The system according to claim 1, characterized in that said lifting device is specifically used for lifting the workbench after completion of printing of a first layer of the 3D object on the workbench so as to print a second layer of the 3D object.
